(19) United States
(12) Patent Application Publication
(10) Pub. No.: US 2009/0137139 A1
(43) Pub. Date: May 28, 2009

(54) Fool-proof card connector

(75) Inventors: Gwo-Bin Shiue, Taipei City (TW); Li-Guang Zou, Hunan (CN)

Correspondence Address: BACON & THOMAS, PLLC, 625 SLATERS LANE, FOURTH FLOOR, ALEXANDRIA, VA, 22314-1176, US

(73) Assignee: TAI-SOL ELECTRONICS CO., LTD., TAIPEI CITY (TW)

(21) Appl. No.: 12/073,188

(22) Filed: Mar. 3, 2008

(30) Foreign Application Priority Data
Nov. 26, 2007 (TW) 96219987

(51) Int. Cl. H01R 13/62

(52) U.S. Cl. 439/160

(57) ABSTRACT

A fool-proof card connector includes a housing that has an opening, a card-receiving space, a chamber in a sidewall at one side of the chamber, a stop block that is pivotally mounted in the chamber and has a stop face, and a spring member mounted in the chamber for biasing the stop block toward the outside of the chamber to a biased position where the stop face of the stop block is suspending in the card-receiving space to stop incorrect insertion of a MS memory card.

### BACKGROUND OF THE INVENTION

1. Field of the Invention

The present invention relates to electrical connection devices and more particularly, to a fool-proof card connector that prevents insertion of a memory card in an incorrect direction.

2. Description of the Related Art

For storing a big amount of digital data, a notebook computer, digital camera, PDA or any of a variety of electronic devices may be provided with a function that allows insertion of a memory card so that the electronic device can store data in the inserted memory card.

There are many types of commercial memory cards, including MS (Memory Stick), SD (Secure Digital), MMC (Multi-Media Card), and XD (eXtreme Digital). To allow the use of different memory cards in an electronic device and to save the installation space, a multi-in-one card connector shall be used. A multi-in-one card connector generally comprises a housing and multiple sets of metal terminals. The metal terminals respectively extend to the inside of the housing. The housing has an opening through which a memory card is insertable into the inside of the housing to electrically contact the corresponding metal terminals for allowing the electronic device in which the multi-in-one card connector is installed to read data from the inserted memory card.

In the aforesaid various different memory cards, a MS memory card has an elongated rectangular shape, and the metal contacts of a MS memory card are arranged at its one short side. Therefore, when using a MS memory card, the user must properly insert the correct short side of the MS memory card into the card connector for reading. If the user inserts the wrong side of the memory card into the card connector, the inserted memory card may touch a different set of metal terminals, causing deformation or damage of the different set of metal terminals.

### SUMMARY OF THE INVENTION

The present invention has been accomplished under the circumstances in view. It is one object of the present invention to provide a fool-proof card connector that prevents insertion of a MS memory card in a wrong direction.

To achieve this and other objects of the present invention, the card connector comprises a housing, a stop block, and a spring member. The housing has an opening, two opposite sidewalls, and a card-receiving space extending from the opening and defined between the sidewalls. One sidewall has a chamber, a stop portion at one side of the chamber, and a first positioning portion disposed inside the chamber. The stop block has a stop face and a coupling portion. The coupling portion is disposed at one end of the stop block and pivotally coupled to the first positioning portion for enabling the stop block to be biased in and out of the chamber. The spring member is mounted in the chamber and adapted for biasing the stop block toward the outside of the chamber to a biased position where a part of the other end of the stop block is stopped against the stop portion of the housing and the stop face of the stop block is suspending in the card-receiving space. By means of the technical characteristic of the installation of the biasable stop block in the housing, the fool-proof card connector prevents insertion of a MS memory card in an incorrect direction.

### BRIEF DESCRIPTION OF THE DRAWINGS

FIG. 1 is a perspective view of a fool-proof card connector in accordance with a first embodiment of the present invention before closing of the cover.

FIG. 2 is an exploded view of a part of the first embodiment of the present invention.

FIG. 3 is a top view of the first embodiment of the first embodiment of the present invention after removal of the cover, showing insertion of a MS memory card into the housing in the correct direction

FIG. 4 is an oblique elevation of the first embodiment of the present invention after removal of the cover, showing insertion of a MS memory card into the housing in a back to front and upside down manner.

FIG. 5 is a top view of FIG. 4.

FIG. 6 is an oblique elevation of the first embodiment of the present invention after removal of the cover, showing insertion of a MS memory card into the housing in an upside down manner.

FIG. 7 is an oblique elevation of the first embodiment of the present invention after removal of the cover, showing insertion of a MS memory card into the housing in a back to front manner.

FIG. 8 is an exploded view of a part of a fool-proof card connector in accordance with a second embodiment of the present invention.

FIG. 9 is an exploded view of a part of a fool-proof card connector in accordance with a third embodiment of the present invention.

FIG. 10 is an exploded view of a part of a fool-proof card connector in accordance with a fourth embodiment of the present invention.

### DETAILED DESCRIPTION OF THE INVENTION

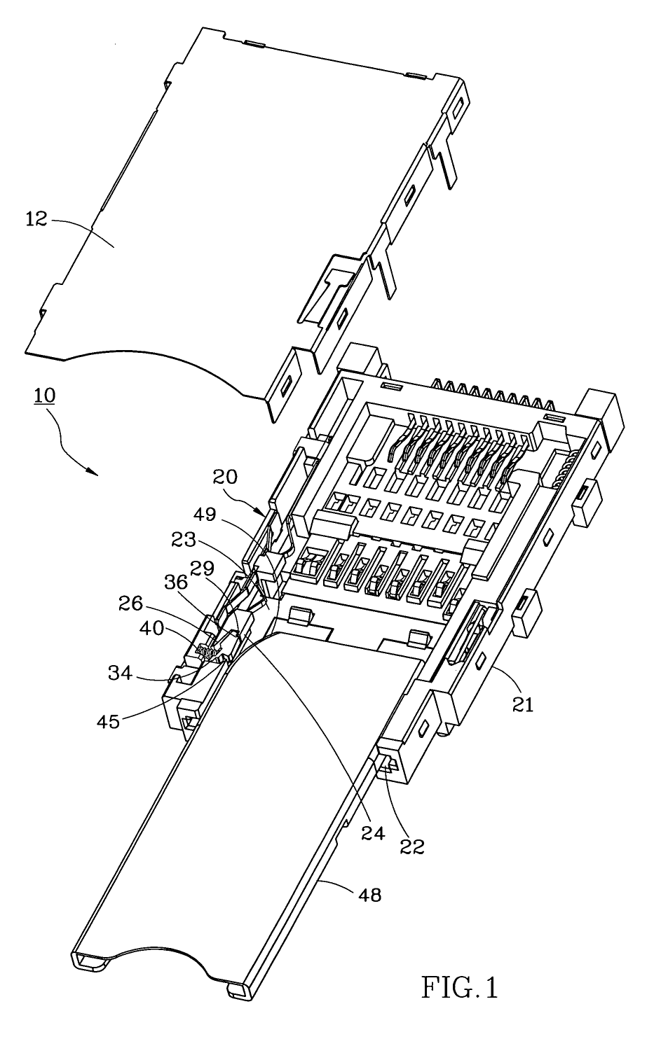

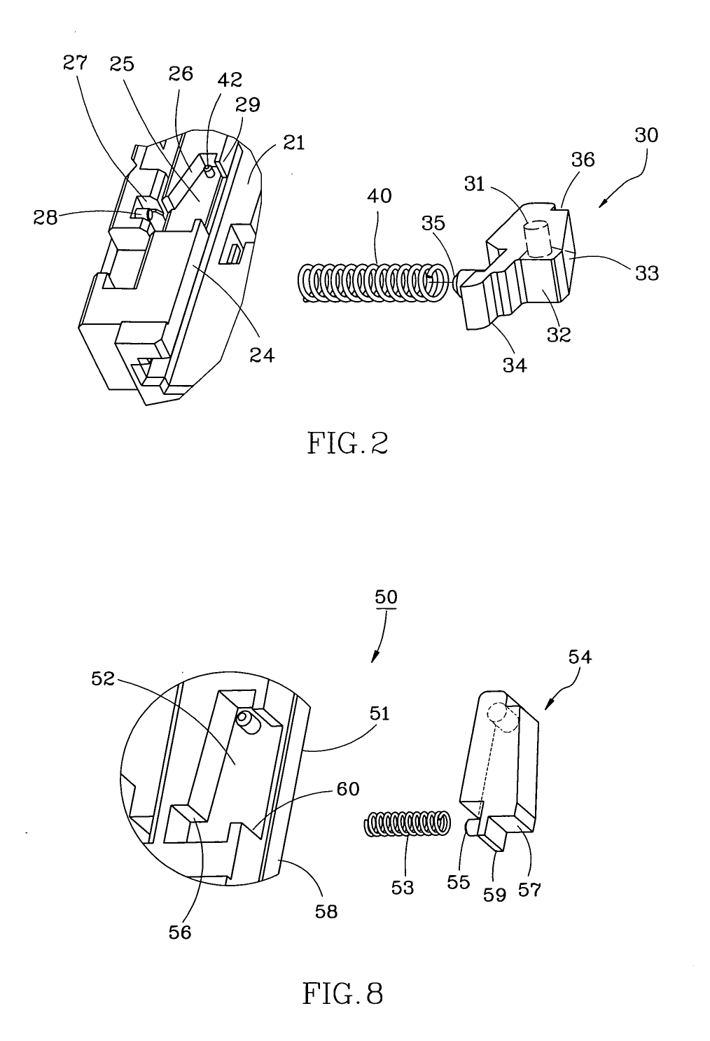

Referring to FIGS. 1˜3, a fool-proof card connector 10 in accordance with a first embodiment of the present invention is shown comprising a housing 20, a stop block 30, and a spring member 40.

The housing 20 is formed of a base frame 21 and a cover 12. The housing 11 has an opening 22, and a card-receiving space 23 extending from the opening 22. The opening 22 and the card-receiving space 23 are defined to fit a MS (memory stick) memory card.

The base frame 21 of the housing 20 has two sidewalls 24 at two sides of the card-receiving space 23. One sidewall 24 defines therein a chamber 25 near the opening 22. The chamber 25 is disposed in communication with the card-receiving space 23. The base frame 21 has a cylindrical first positioning portion 42 vertically disposed in the chamber 25. The chamber 25 has an oblique inside wall 26. The oblique inside wall 26 has a locating groove 27 and a cylindrical locating portion 28 transversely suspending in the locating groove 27. The base frame 21 further has a second positioning portion 29 and a stop portion 45 respectively extended from the sidewall 24 at two sides of the chamber 25.

The stop block 30 has a coupling portion 31 for coupling to the first positioning portion 42 of the base frame 21, a step 36 at one end, a stop face 32 at the other end, a sloping face 33 connected between the coupling portion 31 and the stop face 32, a stop flange 34 extended one side of the stop face 32, and a cylindrical locating portion 35 extending from one side of the stop flange 34. According to this embodiment, the coupling portion 31 is a circular recessed hole. Further, the stop block 30 is mounted in the chamber 25 inside the base frame 21 with its coupling portion 31 coupled to the first positioning portion 42 of the base frame 21 so that the stop block 30 is biasable relative to base frame 21.

The spring member 40 according to this embodiment is a compression spring mounted in the chamber 25 of the base frame 21, having its one end sleeved onto the cylindrical locating portion 28 of the base frame 21 and its other end sleeved onto the cylindrical locating portion 35 of the stop block 30. The spring member 40 imparts a pressure to the stop flange 34 of the stop block 30, biasing the stop block 30 to the position where the stop face 32 is moved with the stop block 30 toward the card-receiving space 23. At this time, the stop flange 34 is stopped against the stop portion 45, and therefore the stop block 30 will not escape out of the chamber 25.

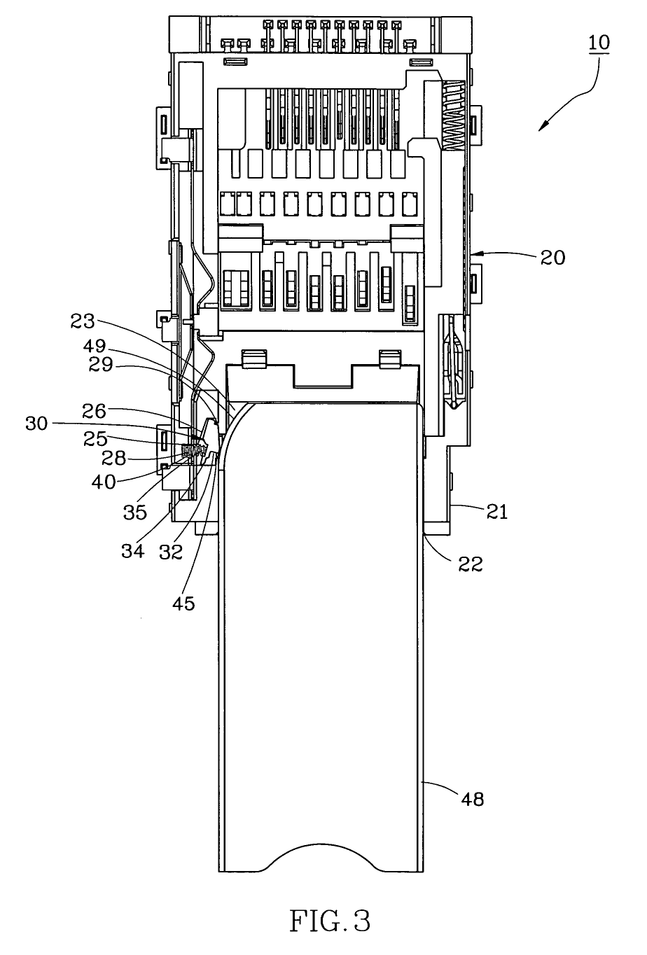

When inserting a MS memory card 48 through the opening 22 of the housing 20 into the card-receiving space 23 in the correct direction, as shown in FIGS. 1 and 3, the smoothly arched end edge 49 of the MS memory card 48 will be forced to touch the outer side of the stop face 32 of the stop block 30, and continuously inserting the MS memory card 48 toward the inside of the card-receiving space 23 will cause the arched end edge 49 to bias the stop block 30, forcing the stop block 30 into the inside of the chamber 25, and therefore the MS memory card 48 can be smoothly inserted into the inside of the housing 20. When removed the MS memory card 48 out of the housing 20, the spring force of the spring member 40 immediately bias the stop block 30 to the position where the stop face 32 projects out of the sidewall 24 into the card-receiving space 23, the step 36 of the stop block 30 is stopped at the second positioning portion 29, and the stop flange 34 is stopped against the stop portion 45.

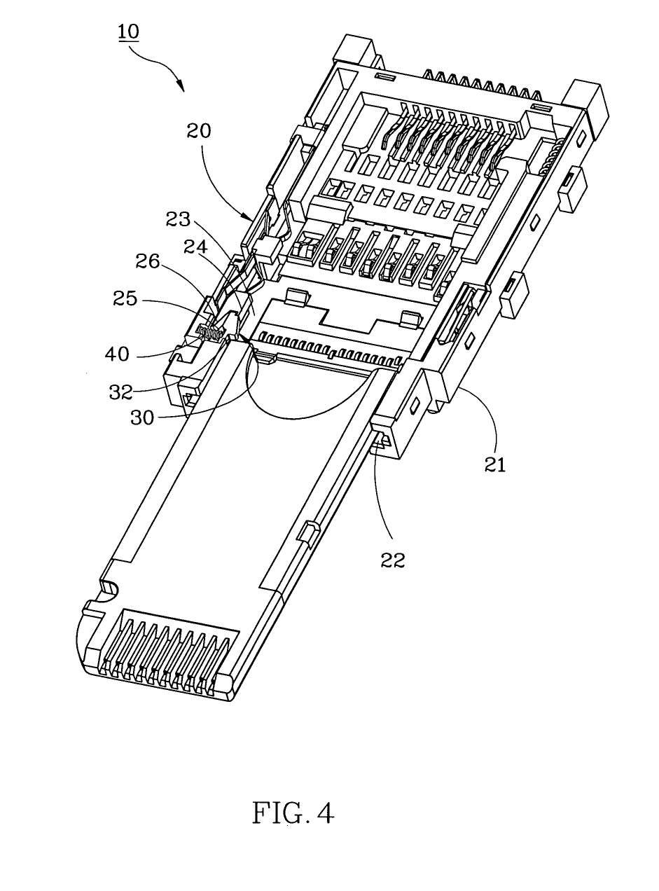

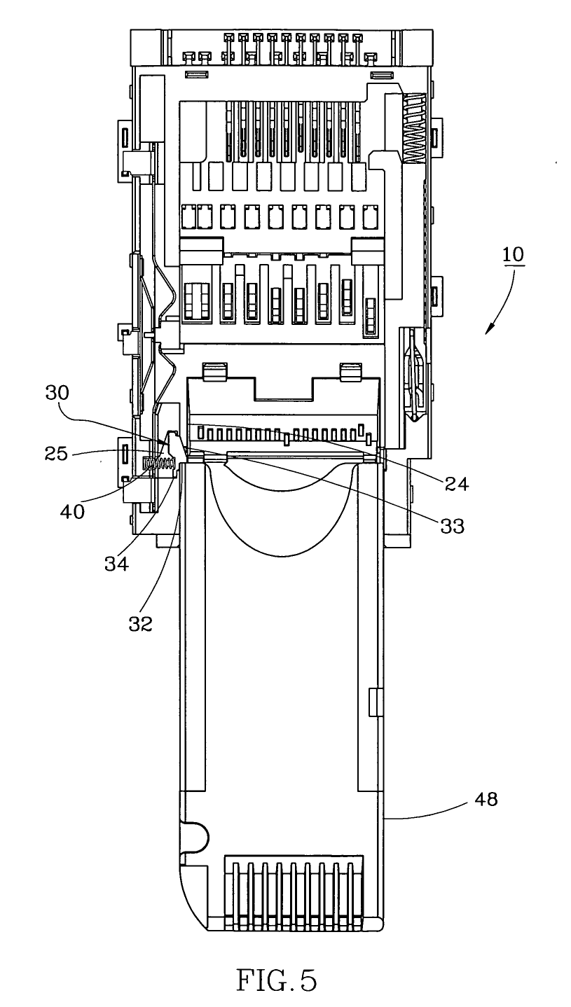

Referring to FIGS. 4 and 5, when inserting a MS memory card 48 erroneously in a back to front and upside down manner. One angled corner edge of the MS memory card 48 will be stopped against the stop face 32 of the stop block 30, and the insertion of the MS memory card 48 will not bias the stop block 30 toward the inside the chamber 25, and the MS memory card 48 will be stopped from forward movement and cannot be inserted into the inside of the housing 20.

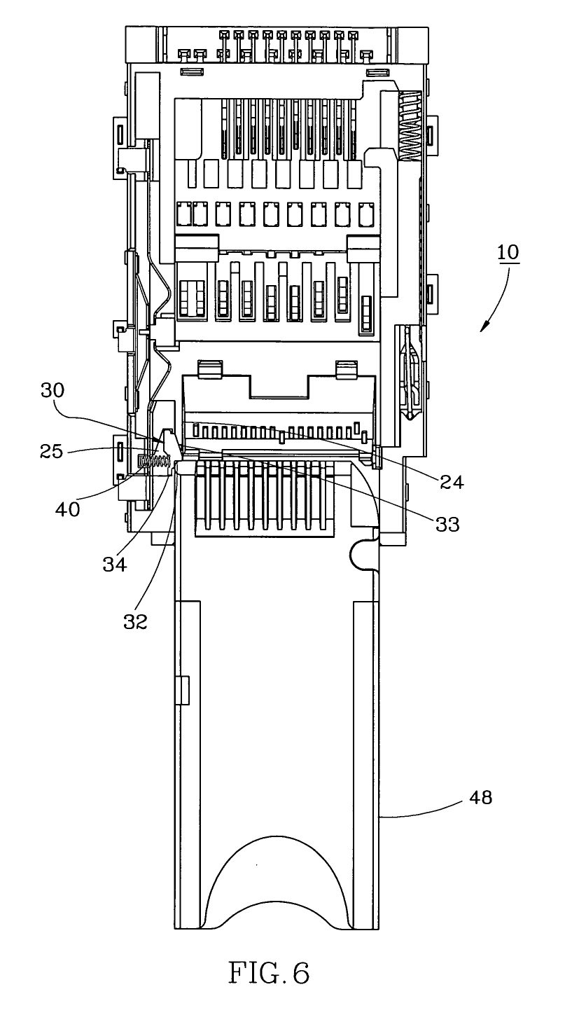

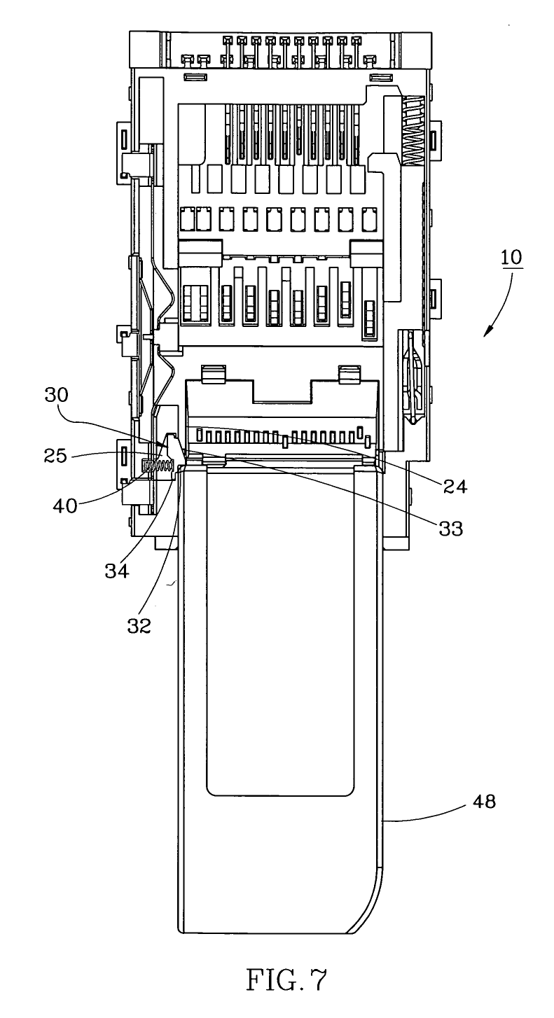

Referring to FIGS. 6 and 7, when inserting a MS memory card 48 erroneously in an upside down manner as shown in FIG. 6 or in a back to front manner as shown in FIG. 7, one angled corner edge of the MS memory card 48 will be stopped against the stop face 32 of the stop block 30, and the insertion of the MS memory card 48 will not bias the stop block 30 toward the inside the chamber 25, and the MS memory card 48 will be stopped from forward movement and cannot be inserted into the inside of the housing 20.

FIG. 8 is an exploded view of a part of a fool-proof card connector 50 in accordance with a second embodiment of the present invention. According to this second embodiment, the chamber 52 of the base frame 51 does not provide the aforesaid locating portion, and the spring member 53 has one end sleeved onto the locating portion 55 at the stop block 54 and the other end positioned in the locating groove 56 inside the chamber 52. By means of this arrangement, the spring force of the spring member 53 imparts a biasing force to the stop block 54 toward the outside of the chamber 52 to the position where the stop face 57 is suspending outside the sidewall 58, the stop flange 59 is stopped against the stop portion 60.

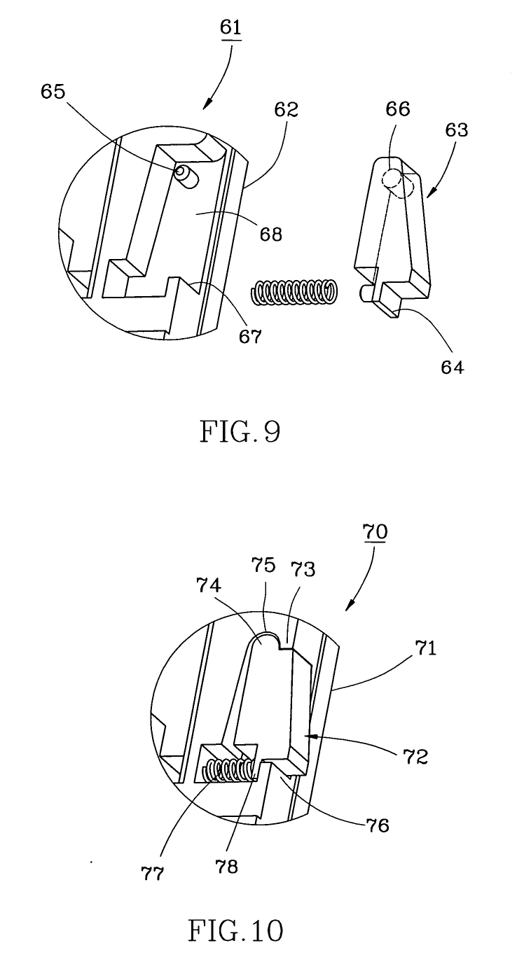

The connection between the stop block and the base frame may be achieved by means of any of a variety of other measures. FIG. 9 is an exploded view of a part of a fool-proof card connector 61 in accordance with a third embodiment of the present invention. According to this third embodiment, the coupling portion 66 of the stop block 63 is coupled to the first positioning portion 65 of the base frame 62 so that the stop block 63 is biasable relative to the base frame 62; the base frame 62 has a stop portion 67 corresponding to the stop flange 64 of the stop block 63; the base frame 62 of this third embodiment eliminates the aforesaid second positioning portion, and the stop block 63 eliminates the aforesaid step. The stop portion 67 is adapted for stopping the stop flange 64 of the stop block 63, so that the stop block 63 will not escape out of the chamber 68.

FIG. 10 is an exploded view of a part of a fool-proof card connector 70 in accordance with a fourth embodiment of the present invention. According to this fourth embodiment, the base frame 71 has a first positioning portion 75, which is a smoothly arched groove, and a second positioning portion 73; the coupling portion 74 of the stop block 72 has a smoothly arched and outwardly curved outer surface fitting the smoothly arched groove of the first positioning portion 75. Subject to the coupling between the smoothed arched and inwardly curved first positioning portion 75 and the smoothly arched and outwardly curved surface of the coupling portion 74 of the stop block 72, the stop block 72 can be biased relative to the base frame 71. When the spring force of the spring member 77 is acting upon the stop block 72, the stop block 72 is biased outward to have its stop flange 78 be stopped against the stop portion 76 of the base frame 71.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A fool-proof card connector comprising:
a housing, said housing having an opening, two opposite sidewalls, a card-receiving space extending from said opening and defined between said sidewalls, one said sidewall comprising a chamber, a stop portion at one side of said chamber, and a first positioning portion disposed inside said chamber;
a stop block, said stop block comprising a coupling portion disposed at a first end thereof and pivotally coupled to said first positioning portion for enabling said stop block to be biased in and out of said chamber, and a stop face; and
a spring member mounted in said chamber and adapted for biasing said stop block toward the outside of said chamber to a biased position where a part of a second end of said stop block opposite to said first end is stopped against said stop portion of said housing and said stop face of said stop block is suspending in said card-receiving space.

2. The fool-proof card connector as claimed in claim 1, wherein said first positioning portion of said housing has a cylindrical shape; said coupling portion of said stop block is a circular recessed hole coupled to said first positioning portion.

3. The fool-proof card connector as claimed in claim 1, wherein said first positioning portion of said housing is a smoothly arched groove; said coupling portion of said stop block has a smoothly arched and outwardly curved outer surface fitting the smoothly arched groove of said first positioning portion.

4. The fool-proof card connector as claimed in claim 1, wherein said base frame comprises a second positioning portion; said stop block has a step that is stopped at said second positioning portion when said stop block is stopped against said stop portion of said housing.

5. The fool-proof card connector as claimed in claim 1, wherein said stop block comprises a locating portion; said spring member is connected between said locating portion of said stop block and said housing.

6. The fool-proof card connector as claimed in claim 1, wherein said housing comprises a locating portion disposed inside said chamber; said spring member is connected between the locating portion of said housing and said stop block.

7. The fool-proof card connector as claimed in claim 1, wherein said stop block comprises a stop flange, which is stopped against said stop portion of said housing when said stop block is biased to said biased position.
